(19) United States
(12) Patent Application Publication
(10) Pub. No.: US 2026/0099063 A1
(43) Pub. Date: Apr. 9, 2026

(54) EYEWEAR HAVING TEMPLES WITH REMOVABLE TEMPLE COVERS

(71) Applicant: Genesis Vision, Inc. DBA Rochester Optical, Rochester, NY (US)

(72) Inventor: Patrick C. HO, Hilton, NY (US)

(73) Assignee: Genesis Vision, Inc. DBA Rochester Optical, Rochester, NY (US)

(21) Appl. No.: 18/909,664

(22) Filed: Oct. 8, 2024

(51) Int. Cl. G02C 5/14; G02C 11/04

(52) U.S. Cl. CPC G02C 5/14; G02C 11/04

(57) ABSTRACT

Eyewear includes a frame and a temple. The temple includes a front end pivotally attached to the frame, a rear end extending to a distal tip of the temple and a mounting core extending therebetween. A temple cover is configured to removably mount on the temple. The temple cover includes a first end portion and a second end portion. The first end portion incudes a mechanical attachment device, such as a retaining hook, that is configured to releasable engage a one of the front or rear end of the temple. The second end portion has one of a first magnetic insert or a first metal insert mounted thereon. The first magnetic insert or first metal insert is configured to magnetically latch to a corresponding second magnetic insert or second metal insert mounted on the other of the front or rear end of the temple.

### TECHNICAL FIELD

The present disclosure relates to eyewear. More specifically, the disclosure relates to eyewear having temples with removable temple covers.

### BACKGROUND

Eyewear, such as eyeglasses, sometimes includes components that may be removed or attached for aesthetic or functional purposes. However, such components are often problematically inconvenient for a user to attach or remove. Further, such changeable components may come in more than one part, may be too inflexible to adequately conform to the contour of a user's head and may include a plurality of magnets or other attachment devices that make the changeable components heavier than necessary and more costly to manufacture than necessary. Additionally, such changeable components are limited in the aesthetic or functional change they make to the eyewear.

By way of example, changeable temple accessories for the temples of eyewear may come in two or more parts, which are not flexible enough to conform to the contours of a user's head and are inconvenient for a user to change. Moreover, such temple accessories may be limited in the aesthetic changes they can make, because for example, the aesthetic appearance of only one side of the temple accessory may be changed. Additionally, such temple accessories may stand out as being a distinct separate part of the temple and do not make the temple look like a single unitary piece when they are mounted on the temple. Additionally, some such temple accessories may easily fall off when the eyewear is dropped or oriented upside down. Further such prior art temple accessories may include multiple magnets, which make the accessory costlier than necessary to manufacture and heavier than necessary to wear.

Accordingly, there is a need for temple accessories that can be conveniently and easily changed, and which allow the user to personally customize or decorate their eyewear. There is also a need for temple accessories that are configured to provide a wide variety of options for aesthetic customization, such as the ability to alter and customize the eyewear with, for example, temple covers of different shapes or lengths, or to alter and customize the eyewear with ornamental designs, symbols, insignias; other ornamentation and embellishments, such as gems, jewels, precious stones, embossment, and fabric; and/or functional modifications, such as electronic and other smart technology components, as just a few examples. Further there is a need for temple accessories that blend in with the rest of the temple, providing the appearance of a single unitary temple. Additionally, there is a need for temple accessories that are less costly to manufacture and lighter than prior art accessories. Moreover, there is a need for temple accessories that are flexible enough to be bent to conform to the contours of a user's head for comfortable fitting.

### BRIEF DESCRIPTION OF THE INVENTION

The present disclosure offers advantages and alternatives over the prior art by providing a removable temple cover, which may be of single piece construction, that may include a mounting groove (or groove), which is designed to straddle a mounting core (or core) in the median portion of a temple. The temple cover includes a first end portion having a mechanical attachment device, such as a retaining hook, that is releasably engageable to either a front or rear end of the temple. The temple cover also includes a second end portion with either a first magnet insert or a first metal insert that is mounted on the second end portion. The first magnet or metal insert is configured to magnetically latch to a second magnet insert or a second metal insert that is mounted on either the front or rear end portion of the temple.

The temple cover (or cover) can advantageously be easily changed. The temple cover may blend in with the temple's front and rear ends to make the entire temple appear as one unitary piece. The temple cover does not easily fall off when the eyewear is dropped or turned upside down. The temple cover can provide a wide variety of aesthetic and/or functional changes to both sides of the temple cover. The temple cover may easily be bent to conform to the contours of a user's head. The temple cover may also be of a single piece construction and/or may include only a single magnet as a latching device, which may make the temple cover lighter and less expensive to manufacture than prior art temple covers.

Eyewear in accordance with one or more aspects of the present disclosure includes a frame and a temple. The temple includes a front end, a rear end and a mounting core. The front end is pivotally attached to a side end of the frame. The rear end extends to a distal tip of the temple. The mounting core extends between the front and rear ends. A temple cover is configured to removably mount on the temple. The temple cover includes a first end portion and a second end portion. The first end portion of the temple cover includes a mechanical attachment device, such as a retaining hook, that is configured to releasable engage a one of the front or rear end of the temple. The second end portion of the temple cover has one of a first magnetic insert or a first metal insert mounted thereon. The first magnetic insert or first metal insert is configured to magnetically latch to a corresponding second magnetic insert or second metal insert mounted on the other of the front or rear end of the temple.

Another eyewear in accordance with one or more aspects of the present disclosure includes a frame a first temple and a second temple. Each temple includes a front end, a rear end and a mounting core. The front end is pivotally attached to one of opposing side ends of the frame. The rear end extends to a distal tip of the temple. The mounting core extends between the front and rear ends. A single piece first and a single piece second temple cover are configured to removably mount on the first and second temples respectively. Each temple cover includes a mounting groove configured to straddle the mounting core of the temple that the temple cover is mounted on. A first end portion of each temple includes a mechanical attachment device, such as a retaining hook, that is configured to releasable engage a one of the front or rear end of the temple that the temple cover is mounted on. A second end portion of each temple has one of a first magnetic insert or a first metal insert mounted thereon. The first magnetic insert or first metal insert is configured to magnetically latch to a corresponding second magnetic insert or second metal insert mounted on the other of the front or rear end of the temple that the temple cover is mounted on.

A temple cover in accordance with one or more aspects of the present disclosure is configured to removably mount on a temple of eyewear. The temple includes a front end pivotally attached to a side end of a frame of the eyewear, a rear end extending to a distal tip of the temple, and a mounting core extending therebetween. The temple cover includes a first end portion and a second end portion. The first end portion of the temple cover includes a mechanical attachment device, such as a retaining hook, that is configured to releasable engage a one of the front or rear end of the temple. The second end portion of the temple cover has one of a first magnetic insert or a first metal insert mounted thereon. The first magnetic insert or first metal insert is configured to magnetically latch to a corresponding second magnetic insert or second metal insert mounted on the other of the front or rear end of the temple.

It should be appreciated that all combinations of the foregoing concepts and additional concepts discussed in greater detail below (provided such concepts are not mutually inconsistent) are contemplated as being part of the inventive subject matter disclosed herein and may be used to achieve the benefits and advantages described herein.

### BRIEF DESCRIPTION OF THE DRAWINGS

The disclosure will be more fully understood from the following detailed description taken in conjunction with the accompanying drawings, in which:

FIG. 1 depicts an example of a front perspective view of eyewear, according to aspects described herein;

FIG. 2 depicts an example of a rear perspective view of the eyewear of FIG. 1, according to aspects described herein;

FIG. 3A depicts an example of an exploded view of the eyewear of FIG. 1, according to aspects described herein;

FIG. 3B depicts an example of an enlarged front view of the area in circle A of FIG. 3A, according to aspects described herein;

FIG. 4 depicts an example of a front perspective view of the eyewear of FIG. 1 with temple covers removed and temple rear ends disconnected from the temple core, according to aspect described herein;

FIG. 5A depicts an example of an enlarged perspective view of the temple cover of the eyewear of FIG. 1, wherein the front end of the temple cover is oriented toward the front end of the temple, according to aspects described herein;

FIG. 5B depict an example of an enlarged perspective view of the temple cover of the eyewear of FIG. 1, wherein the front end of the temple cover is oriented toward the rear end of the temple, according to aspects described herein;

FIG. 6 depicts an example of a front perspective view of the temple covers oriented at an angle for mounting onto the temple cores of the eyewear of FIG. 1, according to aspects described herein;

FIG. 7 depicts an example of a side perspective view of the temple cover partially mounted to the temple cores of the eyewear of FIG. 1, according to aspects described herein;

FIG. 8 depicts an example of a front perspective view of the temple covers fully mounted to the temple cores of the eyewear of FIG. 1, according to aspects described herein;

FIG. 9 depicts an example of a perspective view of a set of two interchangeable temple covers having different designs disposed thereon, wherein one cover is mounted on eyewear, according to aspects described herein;

FIG. 10 depicts an example of a perspective view of the set of temple covers of FIG. 9, with both temple covers removed from the eyewear, according to aspects described herein;

FIG. 11 depicts an example of a perspective view of eyewear with an electronic accessory mounted on the temple cover, wherein the accessory is an LED light, according to aspects described herein;

FIG. 12 depicts an example of a perspective view of eyewear with an electronic accessory mounted on the temple cover, wherein the accessory is a microphone, according to aspects described herein;

FIG. 13 depicts an example of a perspective view of eyewear with an electronic accessory mounted on the temple cover, wherein the accessory is an audio transmitter, according to aspects described herein;

FIG. 14 depicts an example of a perspective view of eyewear with multiple electronic accessories mounted on the temple cover, according to aspects described herein; and

FIGS. 15-166 depict additional examples of eyewear, according to aspects described herein;

FIG. 167 depicts an example of a perspective view of eyewear with a variety of decorative components disposed on a variety of temple covers, according to aspects described herein;

FIG. 168 depicts an example of a perspective view of eyewear with various embodiments of covers and cover shapes, according to aspects described herein.

### DETAILED DESCRIPTION

Certain examples will now be described to provide an overall understanding of the principles of the structure, function, manufacture, and use of the methods, systems, and devices disclosed herein. One or more examples are illustrated in the accompanying drawings. Those skilled in the art will understand that the methods, systems, and devices specifically described herein and illustrated in the accompanying drawings are non-limiting examples and that the scope of the present disclosure is defined solely by the claims. The features illustrated or described in connection with one example may be combined with the features of other examples. Such modifications and variations are intended to be included within the scope of the present disclosure.

The terms “significantly”, “substantially”, “approximately”, “about”, “relatively,” or other such similar terms that may be used throughout this disclosure, including the claims, are used to describe and account for small fluctuations, such as due to variations in processing from a reference or parameter. Such small fluctuations include a zero fluctuation from the reference or parameter as well. For example, they can refer to less than or equal to ±10%, such as less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

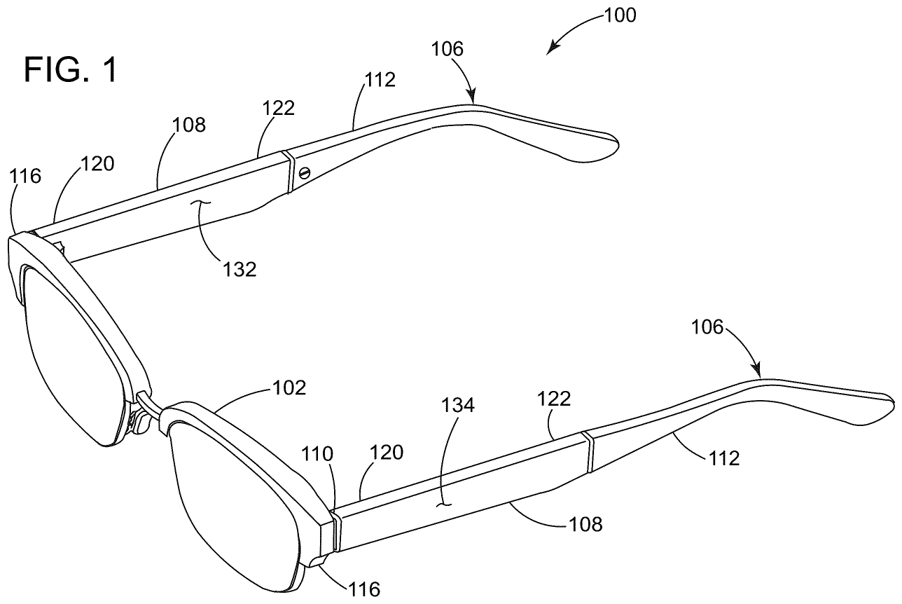

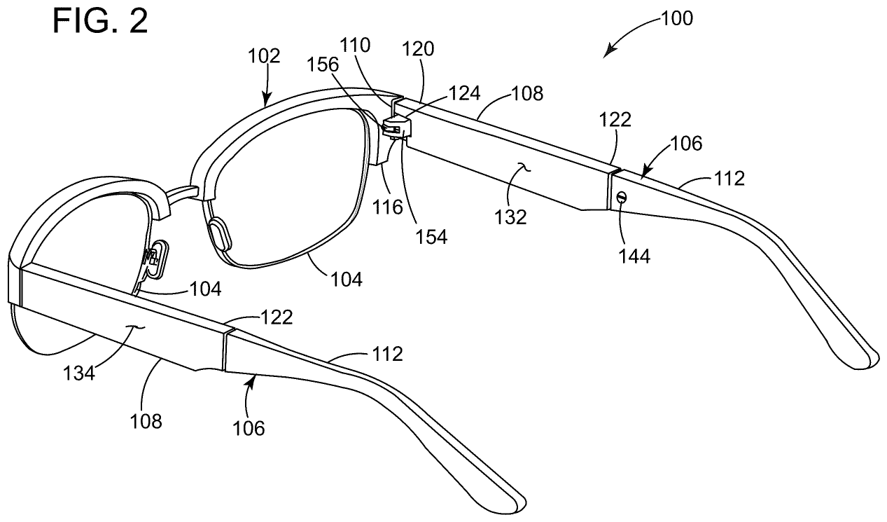

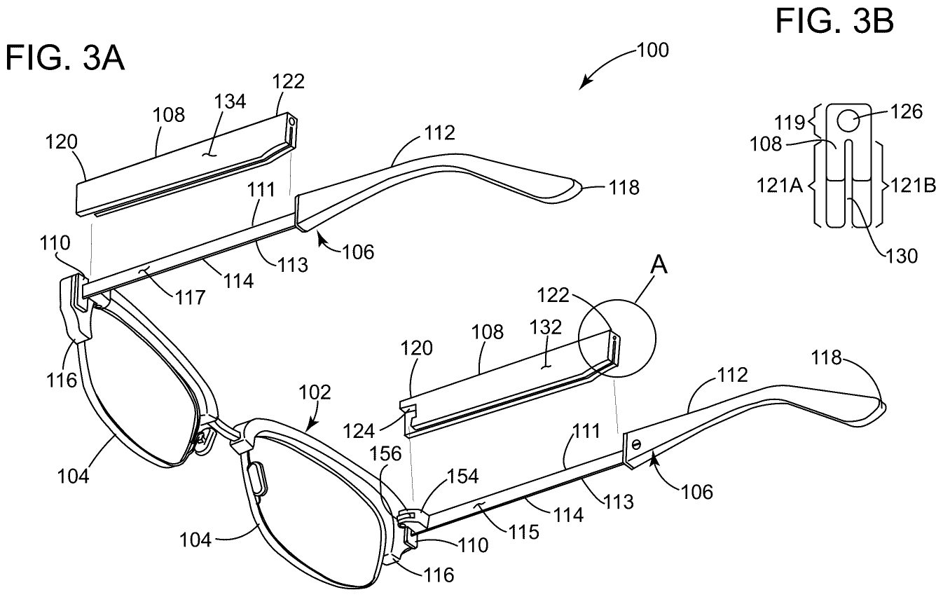

Referring to FIGS. 1, 2 and 3A, examples are depicted of a front perspective view (FIG. 1) a rear perspective view (FIG. 2) and an exploded view (FIG. 3A) of eyewear 100, according to aspects described herein. The eyewear 100 includes a frame 102, a pair of lenses 104 mounted on the frame 102, a pair of temples 106 pivotally connected to the frame 102 and at least one temple cover 108 configure to be removably mounted on at least one of the temples 106. The pair of temples 106 may be referred to herein as a first temple 106 and a second temple 106.

As used herein, when a term includes the adjective “a” or “an” used to modify a noun or noun phrase, that term shall be given the meaning of “at least one” of that noun or noun phrase. By way of a non-limiting example, the term “a temple” means herein “at least one temple.” Accordingly, the term “a temple” may include a single temple, a pair of temples, a first and a second temple or a plurality of temples. Also, by way of a non-limiting example, the term “a cover” means herein “at least one cover” and may also include a single cover, a pair of covers, a first and a second cover or a plurality of covers.

Each temple 106 may include a front end 110, a rear end 112 and a mounting core 114. The front ends 110 are pivotally attached to opposing side ends 116 of the frame 102. The rear ends 112 extend to a distal tip 118 of each temple 106. The mounting cores 114 extend between the front end 110 and the rear end 112 of each temple 106.

The mounting cores 114 may each have a top surface 111, a bottom surface 113, an inner side surface 115 and an outer side surface 117. The top and bottom surfaces 113, 115 are configured to be much narrower than the inner and outer side surfaces 115, 117 in order to enable mounting core 114 to be bendable.

The temple covers 108 are configured to removably mount on the temple 106. Each temple cover 108 may be constructed as a single piece and may include a first end portion 120 and a second end portion 122. As illustrated herein, the first end portion 120 engages with the front end 110 of the temple 106 and the second end portion 122 engages with the rear end 112 of the temple 106. However, it is within the scope of this disclosure that the first end portion 120 may be designed to engage the rear end 112 of the temple 106 and the second end portion 122 may be designed to engage with the front end 110 of the temple.

Though the temple covers 108 are illustrated herein as being a single piece construction, the temple covers 108 may also be constructed as multiple piece assemblies. For example, the temple covers 108 may include a first cover portion and a second cover portion (not shown) that are latched together magnetically or mechanically. The first and second cover portions may latch together around the temple 106.

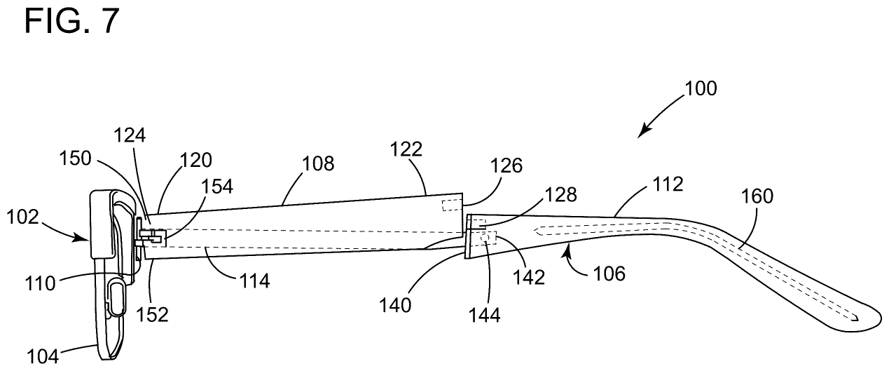

As will be explained in greater detail herein, the first end portion 120 has a mechanical attachment device configured as a retaining hook 124. The retaining hook 124 is configured to releasable engage either the front end 110 or rear end 112 of the temple 106. Also. as will be explained in greater detail herein, the second end portion 122 has either a first insert 126 (which may be either a first magnetic insert 126 or a first metal insert 126) that is mounted on the second end portion 122 (see FIG. 7). The first insert 126 is configured to magnetically latch to a corresponding second insert 128 (which may also be a second magnetic insert 128 or a second metal insert 128) that is mounted on the front end 110 or rear end 112 of the temple 106.

Advantageously, only a single combination of first insert 126 and second insert 128 may be required to magnetically latch the temple cover 108 to the temple 106. Accordingly, the temple cover 108 may be less costly to manufacture and weigh less than other prior art changeable temple covers.

Though a single first magnetic or metal insert 126 is illustrated herein as being disposed on the second end portion 122 of the temple cover 108, other magnetic or metal inserts (not shown) may be disposed along the length of the temple cover 108 to more securely hold the temple cover 108 to the temple 106. The additional magnetic or metal inserts may be configured to magnetically latch the temple cover 108 to the temple 106 at various other locations along the temple cover 108, besides the second end portion 122 of the temple cover 108.

The mounting core 114 of the temple 106 may be composed of a thin flexible metal material. For example, the temple may be composed of a flexible stainless steel material. Other examples of possible materials include other malleable or bendable metals such as titanium or titanium alloy. The mounting core 108 may also comprise a material that is hypoallergenic.

The temple cover 108 may be a suitable plastic substrate or other material suitable and known for use in eyewear. For example, the temple cover substrate may comprise a material that is hypoallergenic. The temple substate may also comprise a material that is bendable. In certain embodiments, the temple substrate may be selected from a group consisting of nylon, cellulose acetate, polycarbonate, acrylic, recycled plastic, or other suitable materials, mixtures and combinations thereof.

By way of example, in an embodiment the temple cover 108 may be composed of a bendable plastic and may be of a single piece construction. For example, the material of the temple cover 108 may be heated with, for example, a hair dryer or other comparable heat source, and softened to the point that it can bend. The temple cover 108 may therefore be bent to a specific shape when heated and later set into that shape once the material is cooled. Accordingly, the combined mounting core 114 and temple cover 108 may be bendable to be able to conform to a shape or contour of an eyewear user's head.

In other embodiments, the temple cover 108 may comprises a substrate selected from the group consisting of wood and natural wood related materials; semi-precious or precious stones such as jade, topaz, sapphire, and others; metal materials (for example with a hollow core for weight reduction) such as gold, silver, platinum, copper, stainless steel, and others; leather and animal skin materials such as crocodile, python and others; and fabric such as silk, cotton, denim.

Referring to FIG. 3B, an example is depicted of an enlarged front view of the area in circle A of FIG. 3A, according to aspects described herein. The enlarged front view of FIG. 3B illustrates an embodiment of the temple cover 108 that may include an upper cover base portion 119 with a pair of parallel cover extensions 121A and 121B, which extend downward from the upper cover base portion 119.

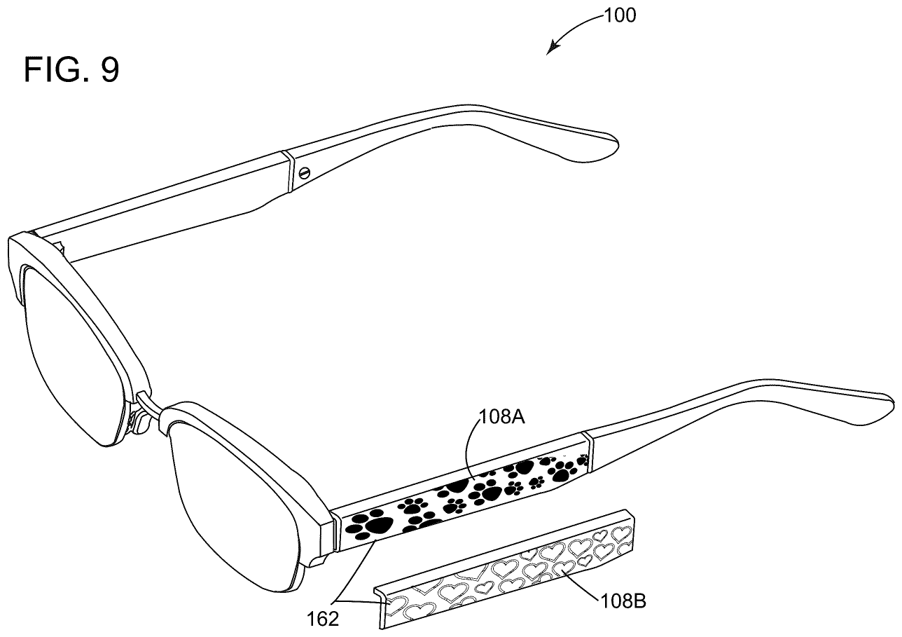

The cover extensions 121A, 121B form a mounting groove 130 therebetween, which extends longitudinally along the entire length of the temple cover 108. The mounting groove 130 is configured to straddle the mounting core 114 of the temple 106, when the temple cover 108 is mounted on the temple core 114. When the mounting groove 130 staddles the mounting core 114, the cover extensions 121A, 121B cover the entire inner and outer side surfaces 115, 117 of the temple core 114, while the upper cover base portion 119 rests upon the top surface 111 of the temple core 114. Therefore, only the bottom surface 113 of the temple core 114 is not covered by the temple cover 108. Advantageously, because the temple cover 108 straddles the mounting core 114, both an inside exterior surface 132 (see FIG. 1) and an outside exterior surface 134 (see FIG. 1) of the temple cover 108 are configured to have various designs (see FIG. 9) disposed thereon.

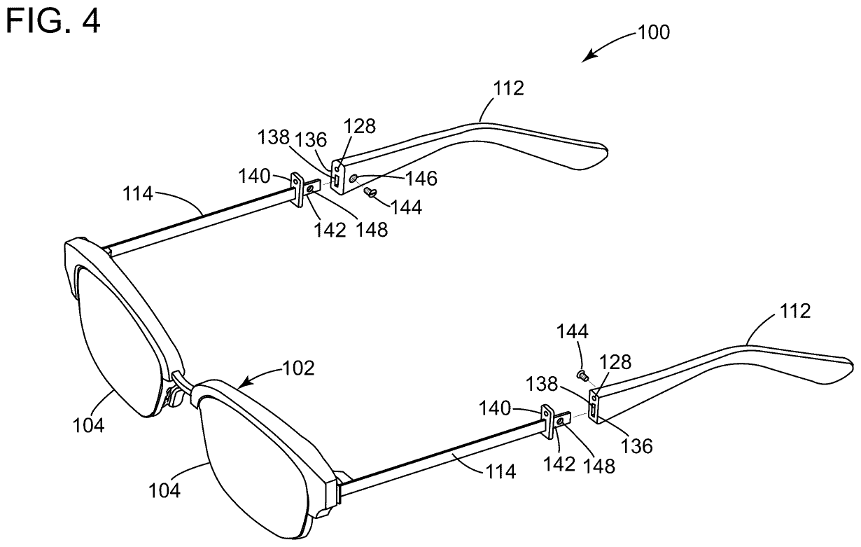

Referring to FIG. 4, an example is depicted of a front perspective view of the eyewear 100 with temple covers 108 removed and temple rear ends 112 disconnected from the temple core 114, according to aspect described herein. Advantageously, the temple rear ends 112 being configured to be removably mounted to the temple core 114, enables the temple rear ends 112 to be changed to coincide with the color or design of different temple covers 108.

Also advantageously, the temple rear ends 112 may be part of a set of temple rear ends, wherein each temple rear end 112 of the set of temple rear ends has a different length to enable adjustment of a total length of the temple 106 of the eyewear 100. The different temple rear end lengths in the set of temple rear ends enables a more comfortable fitting of the eyeglasses to individual users. This is because the position of individual users'ears relative to the front face of the users differs from one user to another. Therefore, the different lengths of the temple rear ends 112 provides the adjustability to the total length of the temples 112 for an optimum fit for different users of the eyewear 100.

More specifically, each temple rear end 112 includes a front face 136 with a receiving slot 138 disposed therein. The receiving slot 138 may be located just below the second magnetic or metal insert 128, which may also be located on the front face 136 of the temple rear end 112.

The temple core 114 includes a mounting plate 140 and a mounting tab 142. The mounting plate 140 is configured to abut against the front face 136 of the temple rear end 112. The mounting tab 142 is configured to extend longitudinally from the mounting plate 140 into the receiving slot 138 of the temple rear end 112.

A set screw 144 is configured to threadingly engage with mounting tab 142 through the temple rear end 112 to removably secure the temple rear end 112 to the temple core 114. More specifically, the set screw 144 may be configured to be inserted through a countersunk thru-hole 146 disposed on the side of the temple rear end 112 proximate the front face 136 of the temple rear end 112. Once inserted into thru-hole 146, the set screw may be configured to threadingly engage with threaded thru-hole 148, which is dispose on the mounting tab 142 of core 114 that has been inserted into the slot 138 of rear end 112. The set screw 144 threaded into the threaded thru-hole 148 of mounting tab 142 securely holds the mounting core 112 and rear end 112 together. The set screw 144 may be unthreaded to separate the rear end 112 from the mounting core 112.

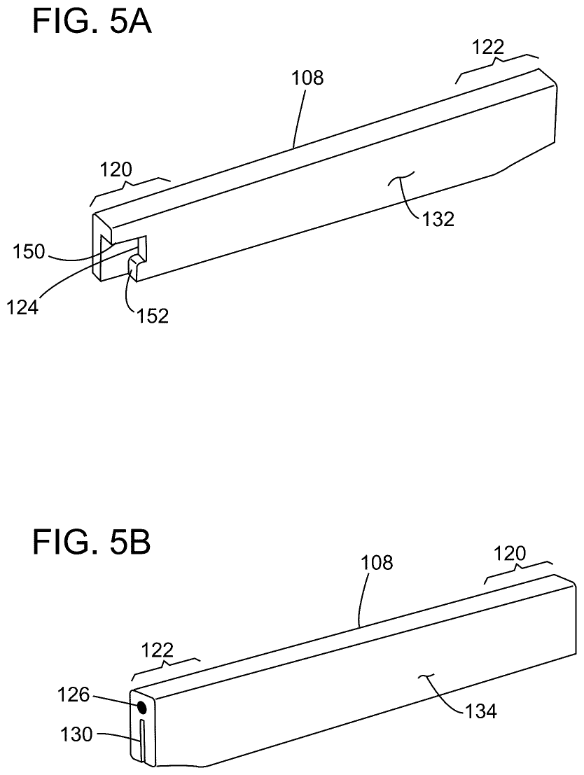

Referring to FIGS. 5A and 5B, an example is depicted of an enlarged perspective view of the temple cover 108 of the eyewear 100, wherein the hooked front end 120 of the temple cover 108 is oriented toward the front end 110 of the temple 106 (FIG. 5A), and wherein the hooked front end 120 of the temple cover 108 is oriented toward the rear end 112 of the temple 106 (FIG. 5B), according to aspects described herein. The temple covers 108 have a mounting groove 130 (see FIG. 5B) that extends longitudinally along the length of the covers 108. The mounting groove 130 is configured to straddle the mounting core 114 of the temple 106. Accordingly, both the inside exterior surface 132 and outside exterior surface 134 are available to have any number of designs disposed thereon.

The temple covers 108 include a first end portion 120 with the retaining hook 124 disposed thereon. The temple covers 108 also include a second end portion 122 with a first magnetic or metal insert 126 mounted thereon. As shown in FIG. 5A, the cover 108 may be configured to mount on the core 144, such that the first end portion 120 may be oriented toward the front end 110 of the temple 106 and the second end portion 122 may be oriented toward the rear end 112 of the temple 106. Alternatively, as shown in FIG. 5B, the cover 108 may be configured to mount on the core 114, such that the first end portion 120 may be oriented toward the rear end 112 of the temple 106 and the second end portion 122 may be oriented toward the front end 110 of the temple 106.

The retaining hook 124 on the first end portion 120 is configured to releasably engage (or releasably hook onto) the front or rear end 110, 112 of the temple 106, depending on how the cover 108 is oriented. In the example illustrated herein, the hook 124 has a top hook extension 150 and a bottom hook extension 152. The top hook extension 150 is configured to engage with and extend over a temple hinge 154 (see FIGS. 2 and 3A), which is mounted on, and is a part of, the front end 110 of the temple 106. The temple hinge 154 is pivotally connected to a frame hinge 156 (see FIGS. 2 and 3A) mounted on a side end 116 of the frame 102. The bottom hook extension 152 is configured to engage with and extend under the temple hinge 154.

Though the mechanical attachment device 124 is illustrated herein as a retaining hook 124, which engages with the temple hinges 154, the mechanical attachment device 124 may include structures other than a hook that are designed to releasably engage with parts of the front end 110 other than the temple hinges 154. For example, the front end 110 may include a body that extends rearward just beyond the temple hinges and has a front face, similar to the front face 136 of rear end 112 in FIG. 4. The front face may also include a receiving slot, similar to receiving slot 138 of rear end 112 in FIG. 4. Accordingly, the mechanical attachment device 124 may include a tab, similar to tab 142 of core 114 in FIG. 4, that is configured to be inserted into the receiving slot on the front end 110.

Also, though the mechanical attachment device 124 is illustrated herein as engaging with the front end 110 (see FIG. 5A), the mechanical attachment device 124 may alternatively be designed to engage with the rear end 112 (see FIG. 5B). In that case, the rear end 112 may have a structure on its front face 136 designed to engage with the mechanical attachment device 124.

The second end portion 122 of the temple cover 108 includes a first insert 126 mounted thereon. The first insert 126, may be a first magnetic insert 126 or first metal insert 126. The first magnetic or metal insert 126 is designed to magnetically latch with a corresponding second insert 128. The second insert 128, may be a second magnetic insert 128 or a second metal insert 128. So, for example, the first and second inserts 126, 128, may both be magnets that are designed to magnetically latch together. Alternatively, one of the first or second inserts 126, 128 may be a magnet and the other may be just a metal insert, wherein the inserts 126, 128 would still magnetically latch together.

Also, though the first magnetic or metal insert 126 is illustrated herein as magnetically latching with the second magnetic or metal insert 128 mounted on the rear end 112 of the temples 106 (see FIG. 7), the second insert 128 may alternatively be mounted on the front end 110 of the temple 106. In that case, the front end 110 may have a structure which includes a front face, similar to the front face 136 in FIG. 4, that the second magnetic or metal insert 126 may be inserted into the. Also in that case, the second end portion 122 of cover 108 would be located toward the front end 110 of the temple 106, when the temple cover 108 is mounted on the temple 106 (see FIG. 5B).

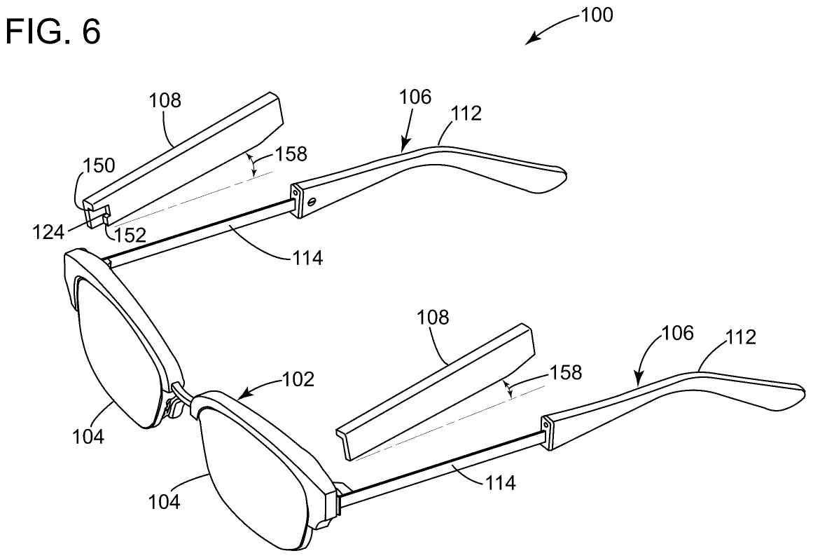

Referring to FIG. 6, an example is depicted of a front perspective view of the temple covers 108 oriented at an acute angle 158 in preparation for mounting onto the temple cores 114 of the eyewear 100, according to aspects described herein. The covers 108 are oriented at an acute angle 158 relative to the mounting core 114 (e.g., 5 to 45 degrees) in order to slip the bottom hook extension 152 of the retaining hook 124 around the temple hinge 154 (see FIG. 2) on the front end 110 of the temple 106.

Referring to FIG. 7, an example is depicted of a side perspective view of the temple cover 108 partially mounted to the temple core 114 of the eyewear 100, according to aspects described herein. In this partially mounted position, the first end portion 120 of the cover 108 is almost fully engaged with the front end 110 of the temple 106 and the second end portion 122 of the cover 108 is about to magnetically latch with the rear end 112 of the temple 106.

More specifically, at the first end portion 120 of the cover 108, the bottom hook extension 152 of the hook 124 has slipped under the temple hinge 154 and the top hook extension 150 now extends over the top of the temple hinge 154. At the second end portion 122 of the cover, the first magnet or metal insert 126 disposed on the second end portion 122 is about to magnetically latch with the second magnet or metal insert 128 disposed on the rear end 112 of the temple 106.

The mounting core 114 of the temple 106 is removably connected to the rear end 112 of the temple 106 via the mounting plate 140, mounting tab 142 and set screw 144. The rear end 112 of the temple 106 is supported and stiffened by a core wire 160 disposed in the rear end 112. The cover 108 is sized to mount flush against the mounting plate 140 of the core 114 to enable the first and second inserts 126, 128 to magnetically latch.

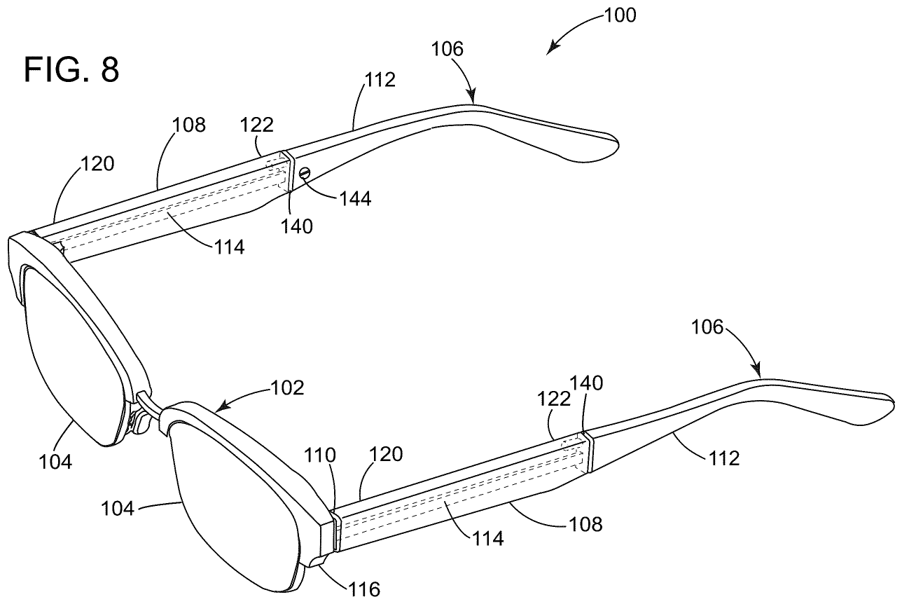

Referring to FIG. 8, an example is depicted of a front perspective view of the temple covers 108 fully mounted to the temple cores 114 of the eyewear 100, according to aspects described herein. When fully mounted, the temple covers 108 are flush against the mounting plate 140 of the mounting core 114 and visually blend in with the rear end 112 of the temple 106 to give the appearance of a single piece temple 106.

The temple cover 108 removably mounts onto the core 114 via the mechanical attachment device (in this case retaining hook) 124 on the front end portion 120 (see FIG. 7) of the cover 108 and the magnetically latching first insert 126 (see FIG. 7) on the second end portion 122 of the cover 108. Advantageously, the attachment of the cover 108 to core 114 is strong enough to prevent the cover 108 from being separated from the core 114 when the eyewear 100 is turned upside down or even when the eyewear 100 is dropped. Yet, the cover 108 may more easily be removed from the core 114 than prior art temple covers.

As described earlier herein, the mechanical attachment device 124 on the first end portion 120 of the cover 108 may be configured to releasable engage one of the front or rear end 110, 112 of the temple 106. Additionally, the first magnetic insert 126 or a first metal insert 126 mounted on the second end portion 122 of the cover 108 may be configured to magnetically latch to the corresponding second magnetic insert 128 or second metal insert 128 mounted on the other of the front or rear end 110, 112 of the temple 106.

In other words, the cover 108 may be designed so that its first end 120, with its mechanical attachment device 124, releasably engages either the front end 110 of the temple 106 or the rear end 112 of the temple 106. Accordingly, whichever end 110, 112 of the temple 106 that the first end 120 of the cover 108 is designed to engage with, then the second end 122 of the cover 108 will be designed to magnetically latch to the other end 110, 112 of the temple 106.

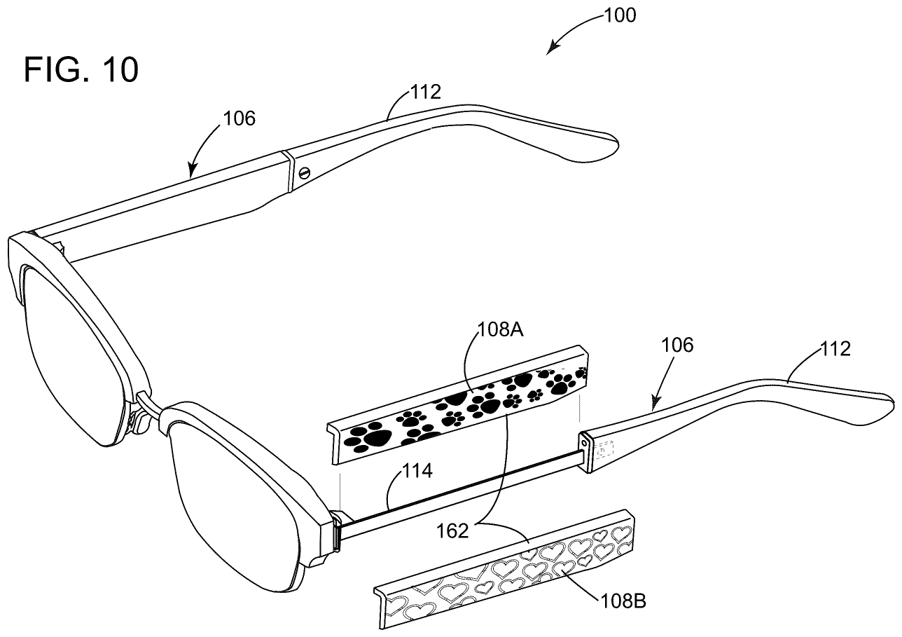

Referring to FIGS. 9 and 10, an example is depicted of a perspective view of a set 162 of two interchangeable temple covers 108A, 108B having different designs disposed thereon, wherein one cover 108A is mounted on the eyewear 100 (FIG. 9) and wherein both temple covers 108A, 108B are removed from the eyewear 100 (FIG. 10), according to aspects described herein.

Each temple cover 108A, 108B of the set of temple covers 162 may have a different design disposed thereon. In the case illustrated in FIGS. 9 and 10, the designs are logos of various sports teams or athletes. However, the designs may be any design and are not limited to just logos. Moreover, the designs may include any color and may portray any message. Additionally, the set of temple covers 162 is not limited to just two covers 108, but can be any number of covers.

Additionally, because the rear ends 112 of the temples 106 are removable from the mounting cores 114 of the temples 106, the rear ends 112 may also come in sets of multiple rear ends 112 (not shown). The rear ends 112 of each set of rear ends 112 may be designed to match or coincide with the covers 108 of each set 162 of covers 108.

In certain embodiments, the temple cover may be configured to incorporate functional components. For example, the eyewear could be customized or modified to include transmitters/receivers, Bluetooth or GPS components, lights/LEDs, smart technology, radio components, electronic displays, and any other electrical components.

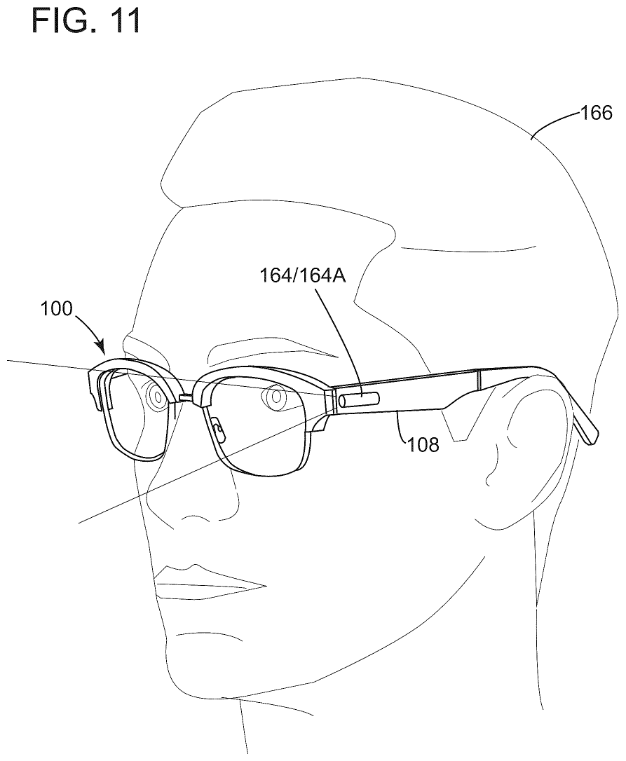

Referring to FIG. 11, an example is depicted of a perspective view of eyewear 100 with an electronic accessory 164 mounted on the temple cover 108, wherein the accessory 164 is an LED light 164A, according to aspects described herein. The temple covers 108 of the eyewear 100 may include a variety of electronic accessories 164 configured to be operated by a user 166 of the eyewear 100. In the example illustrated in FIG. 11, the electronic accessory 164 includes an LED light (or other type of light) 164A that is mounted on the temple cover 108. The light 164A may be configured to illuminate in a direction of vision of the user 166. The light 164A may also have a dimmer control disposed on the cover, to control the intensity of the illumination from the light 164A.

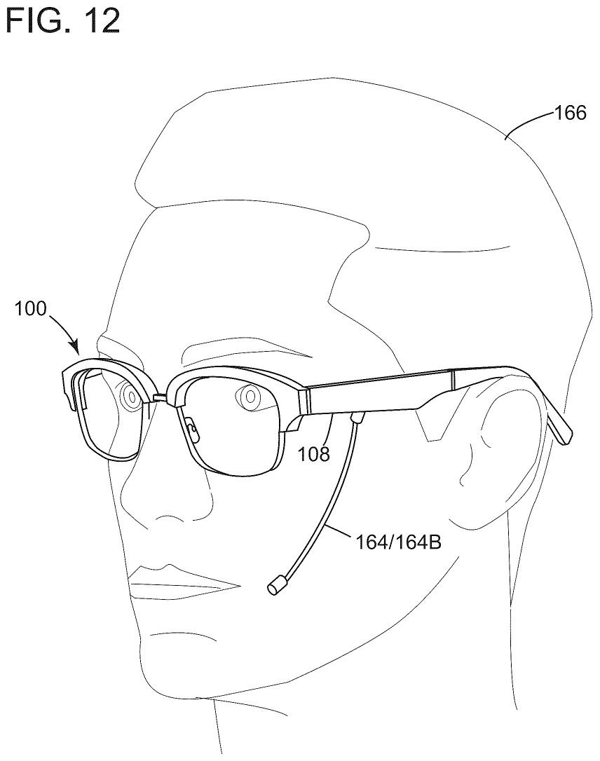

Referring to FIG. 12, an example is depicted of a perspective view of eyewear 100 with an electronic accessory 164 mounted on the temple cover 108, wherein the accessory 164 is a microphone 164B, according to aspects described herein. The microphone 164B may be configured to transmit or record a voice of the user 100.

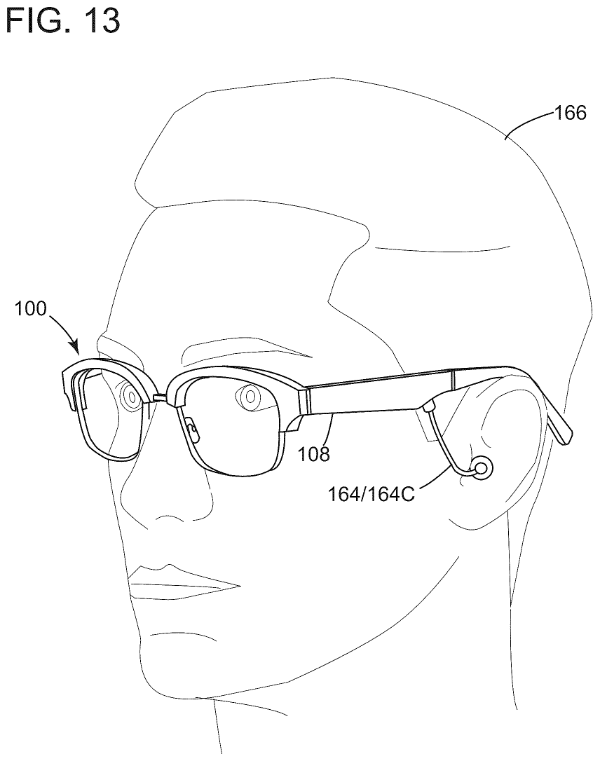

Referring to FIG. 13, an example is depicted of a perspective view of eyewear 100 with an electronic accessory 164 mounted on the temple cover 108, wherein the accessory 164 is an audio transmitter 164C, according to aspects described herein. The audio transmitter 164C may be configured to transmit audio to an ear of the user 166. The audio transmitter 164C could also be used as a hear aid for a user.

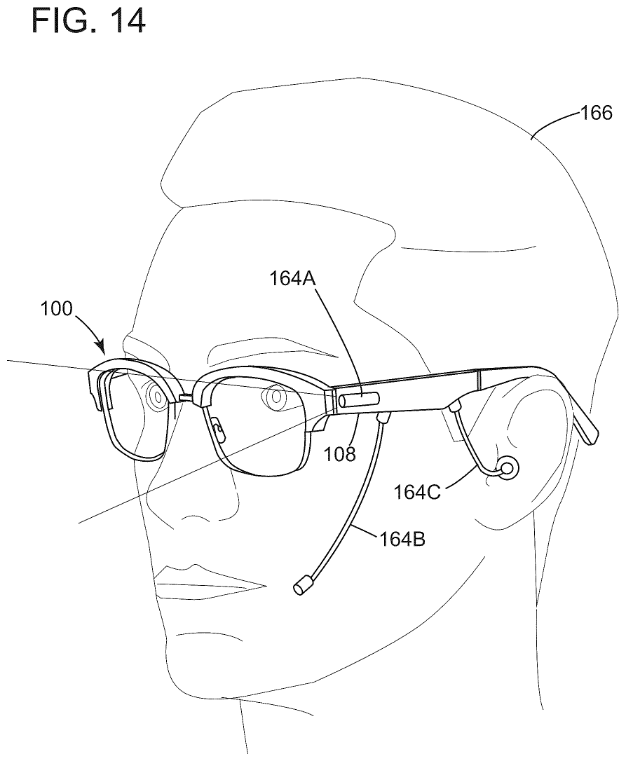

Referring to FIG. 14, an example is depicted of a perspective view of eyewear 100 with multiple electronic accessories 164A, 164B, 164C mounted on the temple cover 108, according to aspects described herein. Any number of electronic accessories 164 may be mounted on the temple covers 108. In the example depicted in FIG. 14, the cover 108 includes an LED light 164A, a microphone 164B and an audio transmitter 164C, which may all be operated by the user 166.

It should be noted that, although this disclosure includes examples of specific ornamental, aesthetic and/or functional components, these are meant to be nonlimiting examples. The current disclosure considers that any ornamental, decorative and/or functional components and materials, whether now known or discovered hereafter, can be utilized with, as or in combination with the temple covers, as described herein. In addition, although interchangeable and therefore temporarily, a user could permanently customize their eyewear in accordance with the description herein.

Referring to FIG. 167, an example is depicted of a perspective view of eyewear with a variety of decorative components 168 disposed on a variety of temple covers 108, according to aspects described herein. In some embodiments, temple covers 108C, 108D may comprises a variety of decorative components 168A, 168B. For example, the decorative component 168A disposed on temple cover 108C may comprise gems, jewels, precious stones, precious metals, embossment, fabric, embroidery or other decorative, ornamental materials that can be interchanged by the user to personalize the eyewear. By way of a more specific example, the decorative component 168A may comprises a gem, such as a diamond, disposed on temple cover 108C. In other embodiments, the decorative component 168B may comprise a component with the initials, logo, name or other textual phrase engraved into the temple cover 108D. It is contemplated by the inventor that various other designs, ornaments or aesthetic modifications can be provided which can be selected and personalized by the wearer.

Referring to FIG. 168, an example is depicted of a perspective view of eyewear 100 with various embodiments of cover types and cover shapes, according to aspects described herein. By way of example, the cover 108 may comprise a straight shaped cover 108E, a generic shaped cover 108F, a cover 108G deigned with a removable insert 170, a cover 108H designed with a metal insert 172, or a cover 108I designed with a safety eye shield 174 disposed thereon.

It should be appreciated that all combinations of the foregoing concepts and additional concepts discussed in greater detail herein (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

Although the invention has been described by reference to specific examples, it should be understood that numerous changes may be made within the spirit and scope of the inventive concepts described. Accordingly, it is intended that the disclosure not be limited to the described examples, but that it has the full scope defined by the language of the following claims.

What is claimed is:

1. Eyewear comprising:
a frame;
a temple, comprising:
a front end pivotally attached to a side end of the frame,
a rear end extending to a distal tip of the temple, and
a mounting core extending therebetween; and
a temple cover configured to removably mount on the temple, the temple cover comprising:
a first end portion having a mechanical attachment device configured to releasable engage a one of the front or rear end of the temple, and
a second end portion having one of a first magnetic insert or a first metal insert mounted thereon, the first magnetic insert or first metal insert being configured to magnetically latch to a corresponding second magnetic insert or second metal insert mounted on the other of the front or rear end of the temple.

2. The eyewear of claim 1, wherein the mechanical attachment device comprises a retaining hook.

3. The eyewear of claim 1, wherein:
the temple comprises a first and a second temple, the first and second temples having front ends pivotally attached to opposing side ends of the frame; and
the temple cover comprises a first and a second temple cover, the first and second temple covers configured to removably mount on the first and second temples respectively.

4. The eyewear of claim 1, wherein the temple cover comprises a mounting groove configured to straddle the mounting core of the temple.

5. The eyewear of claim 1, wherein the temple cover is constructed as a single piece.

6. The eyewear of claim 1, wherein the temple rear end is removably mounted to the temple core.

7. The eyewear of claim 6, wherein:
the temple rear end includes a front face with a receiving slot disposed therein;
the core includes:
a mounting plate configured to abut against the front face, and
a mounting tab configured to extend longitudinally from the mounting plate into the receiving slot of the temple rear end; and
a set screw, configured to threadingly engage with mounting tab through the temple rear end to removably secure the temple rear end to the temple core.

8. The eyewear of claim 6, wherein the temple rear end comprises a set of temple rear ends, wherein each temple rear end of the set of temple rear ends has a different length to enable adjustment of a total length of the temple of the eyewear.

9. The eyewear of claim 1, wherein the mounting core and temple cover are bendable to be able to conform to a shape of an eyewear user's head.

10. The eyewear of claim 1, wherein the temple cover comprises a set of temple covers, wherein each temple cover of the set of temple covers has a different design disposed thereon.

11. The eyewear of claim 1, wherein the temple cover comprises an electronic accessory configured to be operated by a user of the eyewear.

12. The eyewear of claim 11, wherein the electronic accessory comprises a light mounted on the temple cover, the light configured to illuminate in a direction of vision of the user.

13. The eyewear of claim 11, wherein the electronic accessory comprises a microphone mounted on the temple cover, the microphone configured to transmit or record a voice of the user.

14. The eyewear of claim 11, wherein the electronic accessory comprises an audio transmitter, the audio transmitter configured to transmit audio to an ear of the user.

15. Eyewear comprising:
a frame;
a first temple and a second temple, each temple comprising:
a front end pivotally attached to one of opposing side ends of the frame,
a rear end extending to a distal tip of the temple, and
a mounting core extending therebetween; and
a single piece first and a single piece second temple cover configured to removably mount on the first and second temples respectively, each temple cover comprising:
a mounting groove configured to straddle the mounting core of the temple that the temple cover is mounted on,
a first end portion having a retaining hook configured to releasable engage a one of the front or rear end of the temple that the temple cover is mounted on, and
a second end portion having one of a first magnetic insert or a first metal insert mounted thereon, the first magnetic insert or first metal insert being configured to magnetically latch to a corresponding second magnetic insert or second metal insert mounted on the other of the front or rear end of the temple that the temple cover is mounted on.

16. The eyewear of claim 15, wherein the first and second temple covers comprise a set of first and second temple covers, each set of first and second temple covers having a different design disposed thereon.

17. The eyewear of claim 15, wherein at least one of the first and second temple covers comprises an electronic accessory configured to be operated by a user of the eyewear.

18. A temple cover configured to removably mount on a temple of eyewear, the temple including a front end pivotally attached to a side end of a frame of the eyewear, a rear end extending to a distal tip of the temple, and a mounting core extending therebetween, the temple cover comprising:
a first end portion having a mechanical attachment device configured to releasable engage a one of the front or rear end of the temple, and
a second end portion having one of a first magnetic insert or a first metal insert mounted thereon, the first magnetic insert or first metal insert being configured to magnetically latch to a corresponding second magnetic insert or second metal insert mounted on the other of the front or rear end of the temple.

19. The temple cover of claim 18, wherein the mechanical attachment device is a retaining hook.

20. The temple cover of claim 18, wherein the temple cover is constructed as a single piece.

21. The temple cover of claim 18, comprising a mounting groove configured to straddle the core of the temple.

22. The temple cover of claim 18, wherein the temple includes a first and a second temple each having front ends pivotally attached to opposing side ends of the frame, and wherein the temple cover comprises:
a first and a second temple cover, the first and second temple covers configured to removably mount on the first and second temples respectively.

23. The temple cover of claim 18, wherein the temple cover comprises a set of temple covers, wherein each temple cover of the set of temple covers has a different design disposed thereon.

24. The temple cover of claim 18, wherein the temple cover comprises an electronic accessory configured to be operated by a user of the eyewear.

25. The temple cover of claim 24, wherein the electronic accessory comprises one of:
a light mounted on the temple cover, the light configured to illuminate in a direction of vision of the user;
a microphone mounted on the temple cover, the microphone configured to transmit or record a voice of the user; or
an audio transmitter, the audio transmitter configured to transmit audio to an ear of the user.
